(19) United States
(12) Patent Application Publication
(10) Pub. No.: US 2020/0003002 A1
(43) Pub. Date: Jan. 2, 2020

(54) SECURITY DEVICE FOR A WINDOW FRAME

(71) Applicant: Keith A. Walter, York, PA (US)

(72) Inventor: Keith A. Walter, York, PA (US)

(21) Appl. No.: 16/457,136

(22) Filed: Jun. 28, 2019

Related U.S. Application Data
(60) Provisional application No. 62/691,712, filed on Jun. 29, 2018.

(51) Int. Cl. E06B 3/58; E06B 3/54

(52) U.S. Cl. CPC E06B 3/58; E06B 3/5454

(57) ABSTRACT

A security device for a window frame includes: a base which is generally L-shaped in cross section with horizontal and vertical legs, wherein at least one of the legs of the base includes a base snap connector; and a cover which is generally L-shaped in cross section with horizontal and vertical legs, wherein at least one of the legs of the cover includes a cover snap connector configured to engage the base snap connector.

### BACKGROUND OF THE INVENTION

This invention relates generally to window construction, and more particularly to an apparatus and method for improving the security of windows of the type used in a commercial building.

FIG. 1 is a cross-sectional view of a portion of a prior art window frame 1 of the type used to hold glass in a commercial building such as a retail shop located at street level (e.g., “store front glass”). More particularly, this view is a cross-section of the horizontal member at the bottom of the window frame 1. It will be understood that a typical square or rectangular window includes horizontal members at the top and bottom of the window, joined by vertical members on the left and right sides of the window. The window frame 1 is a multi-part hollow aluminum extrusion and includes a main portion 2 and a glazing bead 3. The glazing bead 3 is configured to snap or hook into the main portion 2. Typically, the window frame 1 is installed into a building structure “B” with the glazing bead 3 on the exterior “E”, opposite the interior “I”.

Window glass 4 is installed into the window frame 1 as follows. First, the window frame 1 is installed into the building structure B. Rubber cushioning blocks 5 are placed into the main portion 2. The glass 4 is mounted into the window frame 1 by inserting it in the top of the window frame 1 and placing it against the interior of the window frame 1 at the bottom, on top of the rubber cushioning blocks 5. The glazing bead 3 is then snapped into the main portion 2. Finally, resilient sealing elements referred to as “roll rubber gaskets” (or simply “roll gaskets”) 6 are inserted into channels 7 provided in the window frame 1. The roll gaskets 6 are slightly compressed and apply pressure between the window glass 4 and the window frame 1. In addition to a water sealing effect, the roll gaskets 6 prevent the window glass 4 from being removed. Furthermore, pressure applied by the roll gaskets 6 against the glazing bead 3 prevents it from being removed from the main portion 2.

One problem with this type of prior art structure is that it is subject to being breached from the exterior side, permitting unauthorized access to a building, as follows: (1) The roll gasket 6 is removed using a suitable prying tool. (2) The glazing bead 3 is removed. (3) The window glass 4 can then be removed by using suction cups or otherwise by being lifted high enough to remove the rubber cushioning blocks 5. (4) the window glass 4 may then be extracted, at which point the building interior is fully accessible. This process can be reversed to reinstall the window glass 4 and reassemble the window frame 1, without leaving any evidence that a breach has occurred.

### BRIEF SUMMARY OF THE INVENTION

This problem is addressed by an apparatus which blocks access to otherwise easily-removable components of window frames typically used in a commercial building.

According to one aspect of the technology described herein, a security device for a window frame includes: a base which is generally L-shaped in cross section with horizontal and vertical legs, wherein at least one of the legs of the base includes a base snap connector; and a cover which is generally L-shaped in cross section with horizontal and vertical legs, wherein at least one of the legs of the cover includes a cover snap connector configured to engage the base snap connector.

According to another aspect of the technology described herein, a window assembly includes: a frame including a main portion and a removable glazing bead received in the main portion; glass received in the main portion; a roll gasket compressed between the glass and the glazing bead; and a security device, including: a base which is generally L-shaped in cross section with horizontal and vertical legs, wherein at least one of the legs of the base includes a base snap connector; and a cover which is generally L-shaped in cross section with horizontal and vertical legs, wherein at least one of the legs of the cover includes a cover snap connector configured to engage the base snap connector; wherein the base is attached to the glazing bead and the cover is connected to the base using the complementary base and cover snap connectors, such that the cover blocks access to the roll gasket.

According to another aspect of the technology described herein, a method is provided for securing a window assembly of the type having a perimeter frame including a main portion and a removable glazing bead received in the main portion, glass received in the main portion; and a roll gasket compressed between the glass and the glazing bead. The method includes: attaching a base to an exterior of the glazing bead, the base including at least one base snap connector; connecting a cover to the base using mating snap connectors, such that the cover blocks access to the gasket.

### BRIEF DESCRIPTION OF THE DRAWINGS

The invention may be best understood by reference to the following description taken in conjunction with the accompanying drawing figures in which:

FIG. 1 is a cross-sectional view of a portion of a prior art window and window frame installed in a building structure;

FIG. 2 is a front elevational view of a portion of a base of a security device for use with the window frame of FIG. 1;

FIG. 3 is a cross-sectional view taken along lines 3-3 of FIG. 2;

FIG. 4 is a front elevational view of a portion of a cover of security device for use of the window frame of FIG. 1;

FIG. 5 is a cross-sectional view taken along lines 5-5 of FIG. 4;

FIG. 6 is a cross-sectional view of a window frame and window assembly having the base of FIG. 2 attached thereto; and

FIG. 7 is a cross-sectional view of the window frame and window assembly of FIG. 6 having the cover of FIG. 4 installed.

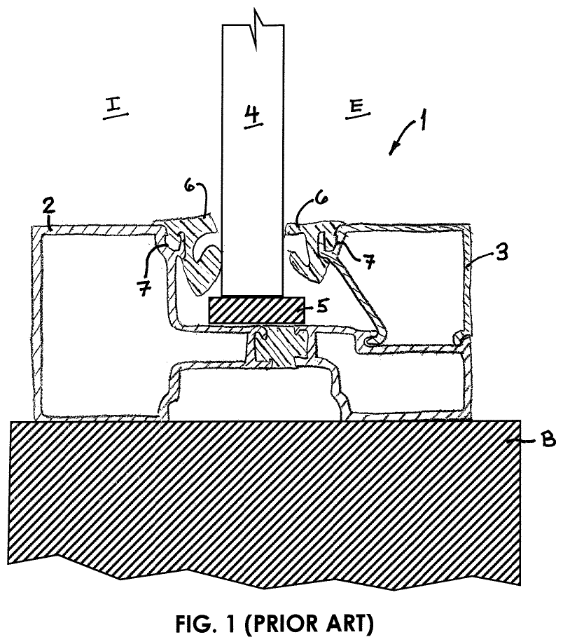

### DETAILED DESCRIPTION OF THE INVENTION

Referring to the drawings wherein identical reference numerals denote the same elements throughout the various views, FIG. 7 illustrates an exemplary security device 10 which is adapted to be installed to the window frame 1 described above, in order to prevent or deter the type of breach described above. The security device 10 comprises a base 12 and a cover 14.

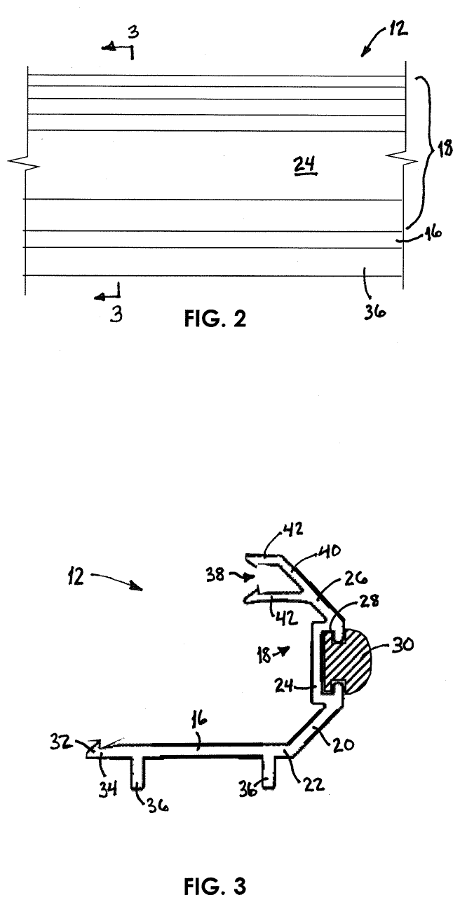

Referring to FIGS. 2 and 3, the base 12 is an elongated member which is generally L-shaped in cross-section, with horizontal and vertical legs 16, 18, respectively. In the illustrated example, the vertical leg 18 includes a lower segment 20 extending at an oblique angle from the proximate end 22 of the horizontal leg 18, a middle segment 24 extending in a vertical direction away from the lower segment 20, and an upper segment 26 extending at an oblique angle from the middle segment 24 back towards the horizontal leg 16. Collectively, the lower segment 20, the middle segment 24, and the upper segment 26 define a generally “C” shaped structure. This “C” shape stiffens the bend of the “L” shape. The vertical leg 18 includes a channel 28, such as undercut or T-shaped channel, for receiving a resilient lower gasket 30, which may be made of natural or synthetic rubber or similar material. In the illustrated example, this channel 28 is part of the middle segment 24.

The horizontal leg 16 includes a lower base snap connector 32 disposed at the distal end 34. The lower base snap connector 32 includes a barb or other structure which is tapered to permit engagement of a mating snap connector, and an undercut shape to prevent disengagement.

The base 12 includes standoffs 36 extending from a lower surface of the horizontal leg 16. The purpose of the standoffs 36 is to elevate the horizontal leg 16 when the base 12 is installed and permit the lower snap connector 32 to operate properly.

The vertical leg 18 includes an upper base snap connector 38 disposed at a distal end 40 of the upper segment 26. The upper base snap connector 38 includes two short, parallel, spaced-apart arms 42, at least one of which includes a barb or other structure which is tapered to permit engagement of a mating snap connector, and an undercut shape to prevent disengagement.

The base 12 may be made of any material having sufficient strength and rigidity to withstand installation and resist easy removal or breakage. Generally, the material would be relatively stiff and have suitable properties for outdoor exposure (e.g., sunlight, rain, etc.). Non-limiting examples of suitable materials include metals such as aluminum and its alloys, polymers such as vinyl, or composites such as glass fiber reinforced plastic.

Optionally, the base 12 or selected portions of it may be provided with treatments or coatings to protect it from oxidation or weather, or to present a desired appearance. Non-limiting examples of treatments or coatings include anodizing, metal plating, paint, or plastic coatings.

In one example, the base 12 may be formed in long sections by a conventional extrusion process. When formed in this manner, the base 12 and all of the sub-components described above may be a single integral, unitary, or monolithic structure.

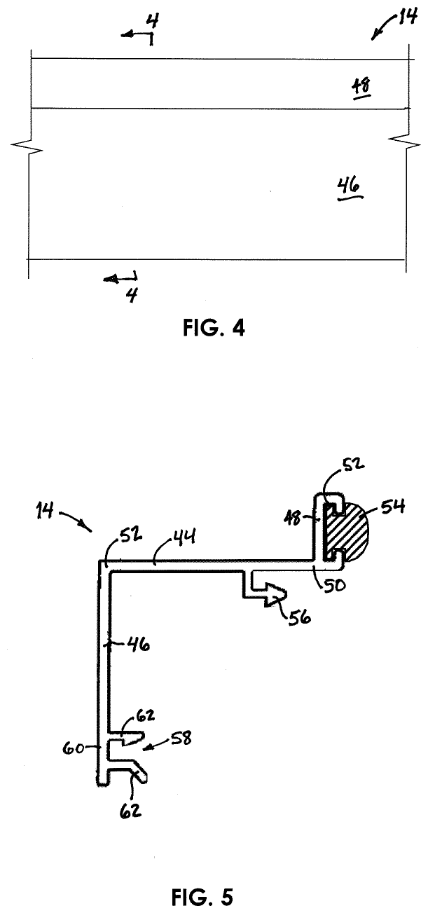

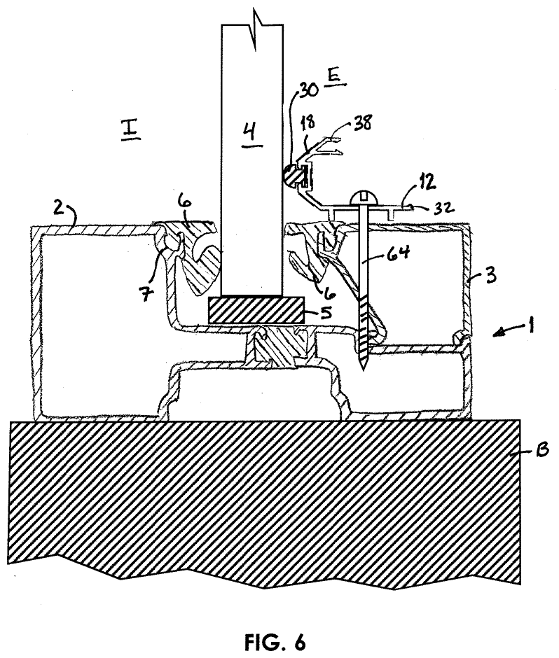

Referring to FIGS. 4 and 5, the cover 14 is also an elongated member which is generally L-shaped in cross-section, with horizontal and vertical legs 44, 46, respectively. The horizontal leg 44 of the cover 14 includes a flange 48 at a distal end 50 which defines a channel 52 for receiving a resilient upper gasket 54.

The cover 14 further includes cover snap connectors which are complementary to the snap connectors 32, 38 of the base 12. The cover snap connectors are sized and shaped such that the cover 14 may be snapped into the base 12 but may not be readily removed.

Specifically, the horizontal leg 44 includes an upper cover snap connector 56 disposed between the distal end 50 and a proximate end 53 of the horizontal leg 44. The upper cover snap connector 56 includes a barb or other structure which is tapered to permit engagement of a mating connector part, and an undercut shape to prevent disengagement. In the illustrated example, the upper cover snap connector 56 has a single barb or “male” configuration sized and shaped to engage the “female” configuration of the upper base snap connector 38 of the base 12. It will be understood that this snap connector arrangement could be reversed, i.e., the upper cover snap connector 56 could be female and the upper base snap connector 38 male, or that other types of connectors could be used.

The vertical leg 46 includes a lower cover snap connector 58 disposed at a distal end 60 thereof. The lower cover snap connector 58 includes two short, parallel, spaced-apart arms 62, at least one of which includes a barb or other structure which is tapered to permit engagement of a mating connector part, and an undercut shape to prevent disengagement. In the illustrated example, the lower cover snap connector 58 has a twin-barb or “female” configuration sized and shaped to engage the “male” configuration of the lower base snap connector 32 of the base 12. It will be understood that this snap connector arrangement could be reversed, i.e., the lower cover snap connector 58 could be male and the lower base snap connector 32 could be female, or other types of connectors could be used.

The cover 14 may be made of any material having sufficient strength and rigidity to withstand installation and resist easy removal or breakage. Generally, the material would be relatively stiff and have suitable properties for outdoor exposure (e.g., sunlight, rain, etc.). Non-limiting examples of suitable materials include metals such as aluminum and it is alloys, polymers such as vinyl, or composites such as glass-fiber reinforced plastic.

Optionally, the cover 14 or selected portions of it may be provided with treatments or coatings to protect it from oxidation or weather, or to present a desired appearance. Non-limiting examples of treatments or coating include anodizing, metal plating, paint, or plastic coatings.

In one example, the cover 14 may be formed in long sections by a conventional extrusion process. When formed in this manner, the cover 14 and all of the sub-components described above may be a single integral, unitary, or monolithic structure.

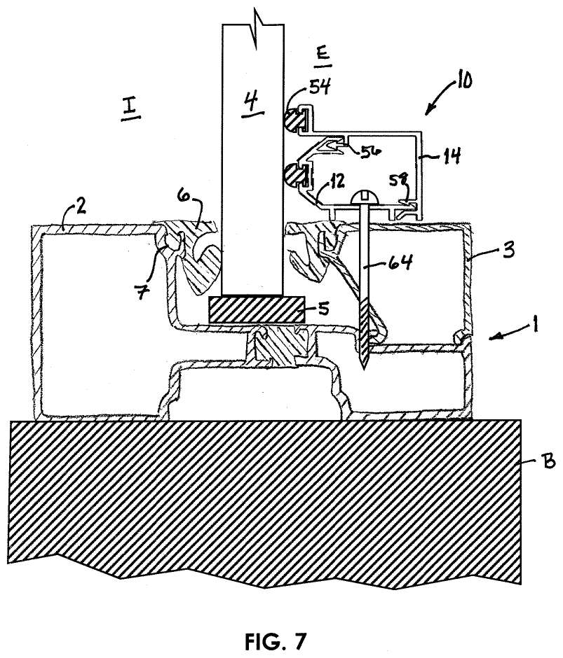

FIGS. 6 and 7 show how the security device 10 may be installed into a window frame 1. As seen in FIG. 6, the base 12 is attached to the glazing bead 3 such that the vertical leg 18 bears against the window glass 4, cushioned by the lower gasket 30. The base 12 may be attached by driving fasteners 64 such as screws through the horizontal leg 16 and into the glazing bead 3. Optionally, the fasteners 64 may be sufficiently long so that they penetrate the entire glazing bead 3 and enter the main portion 2 of the window frame 1. Optionally, the fasteners 64 may be tamper-proof screws with a head design that requires a special tool to install or remove, or which otherwise resists removal.

As seen in FIG. 7, the cover 14 is then snapped into place into the base 12, using the complementary pairs of lower snap connectors 32, 58 and upper snap connectors 38, 56. The characteristics of the snap connectors (i.e., their shape and dimensions) are configured, considering factors such as materials used and the expected environmental conditions, to provide a desired fit when engaged. For example, the snap connectors may be configured so that they can be pressed together in the engaged position using hand pressure or moderate impact, for example using a rubber mallet, but cannot be disconnected without breaking them and/or without using tools. The upper gasket 54 bears against the window glass 4. Thus installed, the security device 10 prevents disassembly of the window frame 1 by blocking access to the roll gaskets 6. It further prevents disassembly of the window frame 1 by applying pressure between the window glass 4 and the glazing bead 3 to prevent removal of the glazing bead 3 from the main portion 2. Furthermore, if the fasteners 64 extend all the way into the main portion 2, these additionally prevent removal of the glazing bead 3.

The cover 14 blocks access to the fasteners 64 preventing them from being easily removed, provides a surface for shedding water, and provides a finished appearance. The entire security device 10 including the base 12 and/or cover 14 may be provided with an appropriate finish (e.g. coating, anodization, paint) to match or complement the window frame 1. The gaskets 30, 54 provide a cushioning effect between the window glass 4 and the security device 10 and also block the entry of water.

Once snapped into place, the cover 14 cannot be easily removed without damaging or destroying it. Removal of the cover 14 will require additional time and is likely to create noise and draw attention, discouraging a potential burglar. Even if the cover 14 is removed, the fasteners 64 (especially the tamper-proof type) provide an additional deterrent, because the glazing bead 3 cannot be removed while the base 12 is in place.

The apparatus and method described herein has numerous benefits compared to the prior art. While described in the context of storefront glass, it will be understood that the security device 10 could be used to secure any similar type of window frame, door frame, etc. Furthermore, it will be understood that the security device 10 could be used for new building construction or newly-installed windows, or it may be used to retrofit existing window frames. It can be retrofitted to existing windows without requiring any design changes to the window frame.

The foregoing has described apparatus and methods for securing a window structure. All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends, or to any novel one, or any novel combination, of the steps of any method or process so disclosed.

What is claimed is:

1. A security device for a window frame, comprising:
a base which is generally L-shaped in cross section with horizontal and vertical legs, wherein at least one of the legs of the base includes a base snap connector; and
a cover which is generally L-shaped in cross section with horizontal and vertical legs, wherein at least one of the legs of the cover includes a cover snap connector configured to engage the base snap connector.

2. The security device of claim 1 wherein:
the horizontal leg of the base includes a lower base snap connector disposed at a distal end thereof; and
the vertical leg of the base includes an upper base snap connector disposed at a distal end thereof.

3. The security device of claim 1 wherein the vertical leg of the base includes a channel that receives a resilient lower gasket.

4. The security device of claim 1 wherein the vertical leg of the base includes:
a lower segment extending at an oblique angle from a proximate end of the horizontal leg;
a middle segment extending in a vertical direction away from the lower segment; and
an upper segment extending at an oblique angle from the middle segment back towards the horizontal leg, wherein collectively, the lower segment, the middle segment, and the upper segment define a C-shaped structure.

5. The security device of claim 1 wherein:
the horizontal leg of the cover includes an upper cover snap connector disposed between proximate and distal ends thereof; and
the vertical leg of the cover includes a lower cover snap connector disposed at a distal end thereof.

6. The security device of claim 1 wherein the vertical leg of the cover includes a channel that receives a resilient upper gasket.

7. The security device of claim 1 wherein at least one of the snap connectors includes an undercut shape to prevent disengagement of the complementary snap connector.

8. A window assembly, comprising:
a frame including a main portion and a removable glazing bead connected to the main portion;
glass received in the main portion;
a roll gasket compressed between the glass and the glazing bead; and
a security device, including:
a base which is generally L-shaped in cross section with horizontal and vertical legs, wherein at least one of the legs of the base includes a base snap connector;
a cover which is generally L-shaped in cross section with horizontal and vertical legs, wherein at least one of the legs of the cover includes a cover snap connector configured to engage the base snap connector;
wherein the base is attached to the frame and the cover is connected to the base using the complementary base and cover snap connectors, such that the cover blocks access to the roll gasket.

9. The window assembly of claim 8 further comprising at least one screw attaching the base to the frame.

10. The window assembly of claim 9 wherein the at least one screw is sufficiently long so as to penetrate the entire glazing bead and enter the main portion of the window frame.

11. The window assembly of claim 8 wherein:
the horizontal leg of the base includes a lower base snap connector disposed at a distal end thereof; and
the vertical leg of the base includes an upper base snap connector disposed at a distal end thereof.

12. The window assembly of claim 8 wherein the vertical leg of the base includes a channel that receives a resilient lower gasket.

13. The window assembly of claim 8 wherein the vertical leg of the base includes:
a lower segment extending at an oblique angle from a proximate end of the horizontal leg;
a middle segment extending in a vertical direction away from the lower segment; and
an upper segment extending at an oblique angle from the middle segment back towards the horizontal leg, wherein collectively, the lower segment, the middle segment, and the upper segment define a C-shaped structure.

14. The window assembly of claim 8 wherein:
the horizontal leg of the cover includes an upper cover snap connector disposed between proximate and distal ends thereof; and
the vertical leg of the cover includes a lower cover snap connector disposed at a distal end thereof.

15. The window assembly of claim 8 wherein the vertical leg of the cover includes a channel that receives a resilient upper gasket.

16. The window assembly of claim 8 wherein at least one of the snap connectors includes an undercut shape to prevent disengagement of the complementary snap connector.

17. A method for securing a window assembly of the type having a perimeter frame including a main portion and a removable glazing bead connected to the main portion, glass received in the main portion, and a roll gasket compressed between the glass and the glazing bead, the method comprising:
attaching a base to an exterior of the frame, the base including at least one base snap connector;
connecting a cover to the base using mating snap connectors, such that the cover blocks access to the gasket.

18. The method of claim 17 wherein at least one of the snap connectors includes an undercut shape to prevent disengagement of the complementary snap connector.

19. The method of claim 17 wherein the base is attached to the frame using at least one screw.

20. The method of claim 17 wherein the at least one screw is sufficiently long so as to penetrate the entire glazing bead and enter the main portion of the window frame.
